(19) United States
(12) Patent Application Publication
(10) Pub. No.: US 2025/0326960 A1
(43) Pub. Date: Oct. 23, 2025

(54) MOISTURE-CROSSLINKABLE COMPOSITION

(71) Applicant: Bostik SA, Puteaux (FR)

(72) Inventors: Federico SANZ, VENETTE (FR); Aurore CARON, VENETTE (FR); Alexia NEIGE, VENETTE (FR)

(21) Appl. No.: 19/184,269

(22) Filed: Apr. 21, 2025

(30) Foreign Application Priority Data
Apr. 23, 2024 (FR) FR2404169

(51) Int. Cl. C09J 175/08; C08G 18/12; C08G 18/30; C08G 18/83; C08K 5/21; C09J 5/00; C09J 11/04; C09J 11/06; C09J 11/08

(52) U.S. Cl. CPC C09J 175/08; C08G 18/12; C08G 18/302; C08G 18/837; C08K 5/21; C09J 5/00; C09J 11/04; C09J 11/06; C09J 11/08

(57) ABSTRACT

A moisture-crosslinkable composition comprises: a polyurethane P1 comprising at least two isocyanate groups; and a polyurethane P2 comprising at least one isocyanate group and one group having the following formula (I):

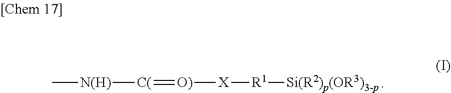

X represents S or NR⁴, R⁴ representing H, an alkyl group, an aryl group, or a cycloalkyl group. R¹ represents a divalent hydrocarbon group comprising from 1 to 12 carbon atoms. p is an integer equal to 0, 1 or 2. Each R², which may be identical or different, represents a linear or branched alkyl group comprising from 1 to 4 carbon atoms. Each R³, which may be identical or different, represents a linear or branched alkyl group comprising from 1 to 4 carbon atoms. The composition is characterized in that the polyurethane P1:polyurethane P2 mass ratio ranges from 50:50 to 99:1.

### CROSS-REFERENCE TO RELATED APPLICATIONS

This application claims priority to French Patent Application No. FR2404169, filed on Apr. 23, 2024.

### FIELD OF THE INVENTION

The present invention relates to a moisture-crosslinkable composition, which can be used in particular in the construction field, and which is capable of forming, after crosslinking, an adhesive joint having good mechanical properties.

### TECHNICAL BACKGROUND

There are various polymer-based compositions on the market, which can be used in many fields, in particular as sealant. Sealants make it possible to assemble (or else to join or bind) two substrates which can be chosen from the most diverse materials, and can also be used as sealing joints. Sealants provide the assembly thus obtained with advantageous mechanical properties of solidity, elasticity and/or flexibility and also fluid tightness.

For example, polymer-based compositions can be used as sealant in building construction, shipbuilding, or the transport sector (for example, road, maritime, rail, or aerospace transport).

Mention may be made, among the desirable properties of a construction sealant, inter alia, of its ability to adhere to a variety of substrates, its resistance to weather conditions (UV, ozone, water), its elasticity, and the like. The capability for movement is a property closely related to the modulus of elasticity. The modulus of elasticity can make it possible to predict the properties of extension or of compression of a sealant. The modulus is typically the ratio between the force (stress) necessary to draw a sealant (strain) and the cross-section of the material at a certain point, typically at 100%. The elongation is the length to which the sealant can extend, expressed as a percentage of its initial size. The modulus has a direct effect on the capability for elongation since the lower the tensile strength, the more easily the mastic can be stretched.

It is advantageous to seek sealants having a high capability for deformation and for resilience (elastic recovery), to adapt to significant movements without generating an excessively high tension on the sealant or the substrate.

In addition, it is common practice to use, in the polyurethane-based sealants, adhesion promoters of epoxysilane type (and derivatives thereof) that do not directly react with the isocyanate functions of the polyurethane, unlike mercaptosilanes or aminosilanes. Epoxysilanes react with the amine function resulting from the reaction of isocyanate functions with water. However, epoxysilanes and their derivatives are typically small molecules the content of which must be restricted in view of their chemical classification, and which might be banned in the future.

There is therefore a need for novel compositions suitable for the preparation of sealant exhibiting a good compromise between good mechanical properties, good elastic properties (elongation and elastic recovery) and good adhesion properties.

### Composition

The present invention relates to a moisture-crosslinkable composition comprising:
a polyurethane P1 comprising at least two isocyanate groups;
a polyurethane P2 comprising at least one isocyanate group and one group having the following formula (I):

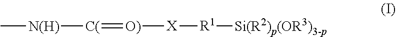

in which:
X represents S or NR⁴, R⁴ representing H, an alkyl group, an aryl group, or a cycloalkyl group;
R¹ represents a divalent hydrocarbon group comprising from 1 to 12 carbon atoms;
p is an integer equal to 0, 1 or 2, preferably 0 or 1;
each R², which may be identical or different, represents a linear or branched alkyl group comprising from 1 to 4 carbon atoms;
each R³, which may be identical or different, represents a linear or branched alkyl group comprising from 1 to 4 carbon atoms;
said composition being characterized in that the polyurethane P1:polyurethane P2 mass ratio ranges from 50:50 to 99:1.

Preferably, in the composition the polyurethane P1:polyurethane P2 mass ratio ranges from 70:30 to 99:1, more preferentially still from 80:20 to 99:1.

### Polyurethane P1

Preferably, the polyurethane P1 comprises at least two isocyanate groups in the terminal position.

The polyurethane P1 is preferably obtained via a process comprising a step E1 of polyaddition reaction:
i) of a composition comprising at least one polyol; and
ii) of a composition comprising at least one polyisocyanate;
in amounts such that the NCO/OH molar ratio (r1) is greater than 1.

Within the context of the invention, and unless otherwise mentioned, r₁ is the NCO/OH molar ratio corresponding to the molar ratio of the number of isocyanate groups (NCO) to the number of hydroxyl groups (OH) borne respectively by all of the polyisocyanate(s) and polyol(s) present in the reaction medium of step E1.

Preferably, the NCO/OH molar ratio (r1) ranges from 1.0 to 2.0, preferably from 1.2 to 2.0.

### Polyol

The term “polyol” is understood to mean a compound comprising at least two hydroxyl groups (—OH).

The polyol(s) used according to the invention may be chosen from those having a number-average molecular mass (Mn) which ranges from 50 to 50 000 g/mol, preferably from 100 to 20 000 g/mol, preferentially from 500 to 20 000 g/mol and advantageously from 500 to 5000 g/mol.

Their hydroxyl functionality may range from 2 to 6, preferentially from 2 to 3. The hydroxyl functionality is the average number of hydroxyl functions per mole of polyol.

The polyol(s) that can be used may be chosen from polyester polyols, polyether polyols, polyene polyols, polycarbonate polyols, poly(ether-carbonate) polyols, and mixtures thereof.

The polyol(s) that can be used may be chosen from aromatic polyols, aliphatic polyols, arylaliphatic polyols and the mixtures of these compounds.

The polyester polyols may be chosen from polyester diols and polyester triols, and preferably from polyester diols.

Among the polyester polyols, examples that may be mentioned include:
polyester polyols of natural origin, such as castor oil;
polyester polyols resulting from the polycondensation:
   of one or more aliphatic (linear, branched or cyclic) or aromatic polyols, for instance monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer, and mixtures thereof, with
   one or more polycarboxylic acids or an ester or anhydride derivative thereof, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer, and mixtures of these acids, an unsaturated anhydride, for instance maleic or phthalic anhydride, or a lactone, for instance caprolactone;
estolide polyols resulting from the polycondensation of one or more hydroxy acids, such as ricinoleic acid, with a diol (examples that may be mentioned include Polycin® D-1000 and Polycin® D-2000 available from Vertellus).

The abovementioned polyester polyols may be prepared conventionally and are for the most part available commercially.

Among the polyester polyols, mention may for example be made of the following products having a hydroxyl functionality equal to 2: TONE® 0240 (sold by Union Carbide) which is a polycaprolactone with a number-average molecular mass of approximately 2000 g/mol, and a melting point of approximately 50° C., DYNACOLL® 7381 (sold by Evonik) with a number-average molecular mass of approximately 3500 g/mol, and having a melting point of approximately 65° C., DYNACOLL® 7360 (sold by Evonik) which results from the condensation of adipic acid with hexanediol, and has a number-average molecular mass of approximately 3500 g/mol, and a melting point of approximately 55° C., Dekatol® 3008 (sold by Bostik) with a number-average molar mass Mn in the region of 1060 g/mol and the hydroxyl number of which ranges from 102 to 112 mg KOH/g. It is a product resulting from the condensation of adipic acid, diethylene glycol and monoethylene glycol.

The polyether polyol(s) that can be used according to the invention is (are) preferably chosen from polyoxyalkylene polyols, the linear or branched alkylene portion of which comprises from 1 to 4 carbon atoms, more preferentially from 2 to 3 carbon atoms.

More preferentially, the polyether polyol(s) that can be used according to the invention is (are) preferably chosen from polyoxyalkylene diols or polyoxyalkylene triols, the linear or branched alkylene portion of which comprises from 1 to 4 carbon atoms, more preferentially from 2 to 3 carbon atoms, and mixtures thereof.

As examples of polyoxyalkylene diols or triols that can be used according to the invention, mention may be made of: polyoxypropylene diols or triols (also denoted polypropylene glycol (PPG) diols or triols) having a number-average molecular mass (Mn) ranging from 500 g/mol to 12 000 g/mol; polyoxyethylene diols or triols (also denoted polyethylene glycol (PEG) diols or triols) having a number-average molecular mass (Mn) ranging from 500 g/mol to 12 000 g/mol; and mixtures thereof.

The abovementioned polyether polyols may be prepared conventionally and are widely available commercially. They may be obtained by polymerization of the corresponding alkylene oxide in the presence of a basic catalyst (for example potassium hydroxide) or a catalyst based on a double metal/cyanide complex.

As examples of polyether diols, mention may be made of the polyoxypropylene diol sold under the name Voranol® P 1010 by Dow, with a number-average molecular mass (Mn) in the region of 1020 g/mol and the hydroxyl number of which is approximately 110 mg KOH/g, or Voranol® P2000 sold by Dow, with a number-average molecular mass in the region of 2040 g/mol and the hydroxyl number of which is approximately 55 mg KOH/g.

The polyene polyol(s) that can be used according to the invention may preferably be chosen from polyenes comprising hydroxyl end groups, and the corresponding hydrogenated or epoxidized derivatives thereof.

Preferably, the polyene polyol(s) that can be used according to the invention is (are) chosen from polybutadienes comprising hydroxyl end groups, which are optionally hydrogenated or epoxidized. Preferentially, the polyene polyol(s) that can be used according to the invention is (are) chosen from butadiene homopolymers and copolymers comprising hydroxyl end groups, which are optionally hydrogenated or epoxidized.

In the context of the invention, and unless otherwise mentioned, the term “hydroxyl end groups” of a polyene polyol is understood to mean the hydroxyl groups located at the ends of the main chain of the polyene polyol.

The hydrogenated derivatives mentioned above can be obtained by complete or partial hydrogenation of the double bonds of a polydiene comprising hydroxyl end groups, and are thus saturated or unsaturated.

The epoxidized derivatives mentioned above can be obtained by chemoselective epoxidation of the double bonds of the main chain of a polyene comprising hydroxyl end groups, and thus comprise at least one epoxy group in its main chain.

Examples of polyene polyols that can be mentioned include saturated or unsaturated butadiene homopolymers comprising hydroxyl end groups, which are optionally epoxidized, for instance those sold under the name Poly BD® or Krasol® by Cray Valley.

The polycarbonate polyols may be chosen from polycarbonate diols or triols.

As examples of polycarbonate diol, mention may be made of Converge® Polyol 212-20 sold by Novomer with a number-average molecular mass (Mₙ) equal to 2000 g/mol the hydroxyl number of which is 56 mg KOH/g, Polyol C1090, C-2090 and C-3090 sold by Kuraray having a number-average molecular mass (Mₙ) ranging from 1000 to 3000 g/mol and a hydroxyl number ranging from 35 to 118 mg KOH/g.

Preferably, the polyurethane P1 is obtained from a composition i) comprising one or more polyether polyols.

Preferably, the polyurethane P1 is obtained from a composition i) comprising a mixture of polyether diol and polyether triol.

### Polyisocyanate

The term “polyisocyanate” is understood to mean a compound comprising at least two isocyanate groups (—NCO).

The polyisocyanate may be chosen from diisocyanates, triisocyanates, and mixtures thereof.

Among the diisocyanates, examples that may be mentioned include the group consisting of isophorone diisocyanate (IPDI), pentamethylene diisocyanate (PDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), (2,5)-bis(isocyanatomethyl)bicyclo[2.2.1]heptane (2,5-NBDI), (2,6)-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (in particular m-xylylene diisocyanate (m-XDI)), toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), tetramethylxylylene diisocyanate (TMXDI) (in particular tetramethyl(meta)xylylene diisocyanate), a PDI allophanate (n=5) or HDI allophanate (n=6) having, for example, the formula (Y) below:

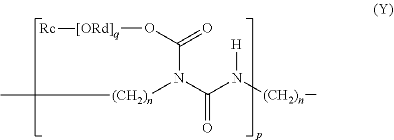

in which p is an integer ranging from 1 to 2, q is an integer ranging from 0 to 9 and preferably 2 to 5, R_{c} represents a saturated or unsaturated, cyclic or acyclic, linear or branched hydrocarbon chain comprising from 1 to 20 carbon atoms, preferably from 6 to 14 carbon atoms, R_{d} represents a linear or branched divalent alkylene group having from 2 to 4 carbon atoms, and preferably a divalent propylene group;
and mixtures thereof.

Among the triisocyanates, examples that may be mentioned include isocyanurates, biurets and adducts of diisocyanates and of triols.

The isocyanurates may be used in the form of a technical mixture of (poly) isocyanurate(s) with a purity of greater than or equal to 70% by weight of isocyanurate(s).

Examples of diisocyanate trimers that may be mentioned include:
the isocyanurate trimer of hexamethylene diisocyanate (HDI):

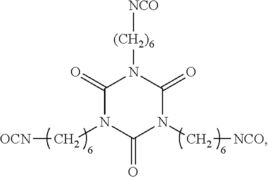

the isocyanurate trimer of isophorone diisocyanate (IPDI):

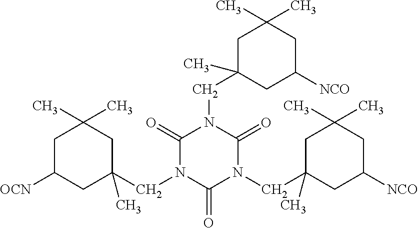

As examples of adducts of diisocyanates and of triols that can be used according to the invention, mention may be made of the adduct of meta-xylylene diisocyanate (m-XDI) with a triol. Such adducts can typically be obtained by addition reaction using said compounds. The methods for such an addition reaction are for example described in EP3101044.

The triol used is preferably a trimethylolalkane comprising an alkane comprising from 1 to 20 carbon atoms and 3 methylol groups, such as, for example, trimethylolmethane, trimethylolethane, trimethylolpropane, trimethylol (n-butane), trimethylolisobutane, trimethylol (s-butane), trimethylol (t-butane), trimethylolpentane, trimethylolhexane, trimethylolheptane, trimethyloloctane, trimethylolnonane, trimethyloldecane, trimethylolundecane and trimethyloldodecane.

More preferably, among the triols that can be used to obtain the adduct of m-XDI and of triol, mention may be made of glycerol of formula HOH₂C—CHOH—CH₂OH, trimethylolmethane (TMM) of formula HC(CH₂—OH)₃, trimethylolethane (TME) of formula H₃C—C(CH₂—OH)₃ and trimethylolpropane (TMP) of formula CH₃—CH₂—C(CH₂—OH)₃.

The MDI may be in the form of an isomer or of a mixture of isomers, such as 4,4′-MDI and/or 2,4′-MDI.

The TDI may be in the form of an isomer or of a mixture of isomers, such as 2,4-TDI and/or 2,6-TDI.

The diisocyanates that can be used are widely available commercially. Mention may be made, by way of examples, of Scuranate® TX sold by Vencorex, corresponding to a 2,4-TDI with a purity of the order of 95%, Scuranate® T100 sold by Vencorex, corresponding to a 2,4-TDI with a purity of greater than 99% by weight, Desmodur® I sold by Covestro, corresponding to an IPDI, or else Isonate® M125 sold by Dow, corresponding to an MDI containing at least 97% of 4,4′-MDI.

Preferably, the polyisocyanate is chosen from diisocyanates.

Preferably, the polyisocyanate is chosen from toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), isophorone diisocyanate (IPDI), xylylene diisocyanate (XDI) (in particular m-xylylene diisocyanate (m-XDI)).

Preferably, the polyurethane P1 is obtained via a process comprising a step E1 of polyaddition reaction:
i) of a composition comprising a polyether diol and a polyether triol;
ii) of a composition comprising a diisocyanate chosen from toluene diisocyanate, diphenylmethane diisocyanate, isophorone diisocyanate, xylylene diisocyanate.

### Step E1

During step E1, the polyaddition reaction may be performed at a temperature ranging from 50° C. to 100° C., for example between 60° C. and 80° C.

The polyaddition reaction of step E1 may be performed in the presence or absence of at least one reaction catalyst.

The catalyst may be any catalyst known to those skilled in the art for catalysing the formation of polyurethane by reaction of at least one polyisocyanate with at least one polyol.

An amount ranging up to 0.3% by weight of catalyst(s), relative to the weight of the reaction medium of step E1, may be used.

The reaction of step E1 may also be performed in the presence of a solvent. The solvent may be chosen from the group consisting of esters, ketones and aromatic compounds, and mixtures thereof. The solvent may be added during step E1) or may come from the starting reactants dissolved in said solvent. The solvent may be chosen, for example, from the group consisting of esters, ketones and aromatic compounds, and mixtures thereof. The solvent may be chosen, for example, from ethyl acetate, butyl acetate, methyl ethyl ketone, methyl isobutyl ketone, toluene, xylene and mixtures thereof.

The polyurethane P1 preferably has a content of NCO groups ranging from 0.5% to 10%, more preferentially from 1% to 8%.

The composition according to the invention preferably comprises from 5% to 60% by weight of polyurethane P1, more preferentially still from 10% to 50% by weight, relative to the total weight of said composition.

### Polyurethane P2

The polyurethane P2 preferably comprises a terminal isocyanate group and an end group having the formula (I):

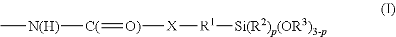

in which:
X represents S or NR⁴, R⁴ representing H or an alkyl group or an aryl group or a cycloalkyl group;
R¹ represents a divalent hydrocarbon group comprising from 1 to 12 carbon atoms;
p is an integer equal to 0, 1 or 2, preferably 0 or 1;
R², which may be identical or different, represents a linear or branched alkyl group comprising from 1 to 4 carbon atoms;
R³, which may be identical or different, represents a linear or branched alkyl group comprising from 1 to 4 carbon atoms.

Preferably, the polyurethane P2 comprises a group of formula (I) in which:
X represents S; and/or
R¹ represents a linear or branched alkylene comprising from 1 to 6 carbon atoms;
and/or
p represents 0; and/or
R³, which may be identical or different, represents methyl or ethyl.

More preferably, the polyurethane P2 comprises a group of formula (I) in which:
X represents S; and
R¹ represents a linear or branched alkylene comprising from 1 to 6 carbon atoms; and
p represents 0; and
R³, which may be identical or different, represents methyl or ethyl.

The polyurethane P2 is preferably obtained via a process comprising a step E2 of reacting a composition comprising a polyurethane P1 with at least one organosilane of the following formula (II):

H—X—R¹—Si(R²)ₚ(OR³)₃₋ₚ (II)

in amounts such that the NCO/XH molar ratio (r2) ranges from 70 to 200, preferably from 90 to 140.

### Step E2

Step E2 may be performed at a temperature ranging from 23° C. to 80° C.

The reaction of step E2 may be performed in the presence or absence of at least one reaction catalyst.

The catalyst may be any catalyst known to a person skilled in the art. An amount ranging up to 0.3% by weight of catalyst(s), relative to the weight of the reaction medium of step E2, may be used.

The reaction of step E2 may also be performed in the presence of a solvent. The solvent may be chosen from the group consisting of esters, ketones and aromatic compounds, and mixtures thereof. The solvent may be added during step E1, during step E2 or may come from the starting reactants dissolved in said solvent. The solvent may be chosen, for example, from ethyl acetate, butyl acetate, acetone, methyl ethyl ketone, methyl isobutyl ketone, toluene, xylene and mixtures thereof.

Within the context of the invention, and unless otherwise mentioned, r₂ is the NCO/XH molar ratio corresponding to the molar ratio of the number of isocyanate groups to the number of XH groups borne respectively by all of the isocyanate(s) (in particular concerning the polyurethane P1) and organosilanes present in the reaction medium of step E2.

The organosilane of formula (II) may be chosen from the group consisting of 2-mercaptoethylmethyldimethoxysilane, 2-mercaptoethyltrimethoxysilane, 2-mercaptoethyltriethoxysilane, 3-mercaptopropylmethyldimethoxysilane, 3-mercaptopropyldimethylmethoxysilane, 3-mercaptopropyltrimethoxysilane, 3-mercaptopropylmethyldiethoxysilane, 3-mercaptopropyltriethyloxysilane, 3-mercaptopropylethyldimethoxysilane, 3-mercaptopropylethyldiethoxysilane, 3-aminopropyltrimethoxysilane, 3-aminopropyltriethoxysilane, 3-aminopropyldiethoxymethylsilane, 3-aminopropyldimethoxymethylsilane, N-butyl-3-aminopropyltrimethoxysilane, N-butyl-3-aminopropyltriethoxysilane, N-phenyl-3-aminopropyltrimethoxysilane, N-phenyl-3-aminopropyltriethoxysilane, and mixtures thereof.

The organosilanes may be commercially available, for instance Dynasylan® 1189 sold by Evonik, or Silquest® A1110 sold by Momentive, or also Dynasylan® MTMO sold by Evonik.

The organosilane of formula (II) is preferably chosen from those in which:
X represents S; and/or
R¹ represents a linear or branched alkylene comprising from 1 to 6 carbon atoms; and/or
p represents 0; and/or
R³, which may be identical or different, represents methyl or ethyl.

More preferably, the organosilane of formula (II) is chosen from those in which:
X represents S; and
R¹ represents a linear or branched alkylene comprising from 1 to 6 carbon atoms; and
p represents 0; and
R³, which may be identical or different, represents methyl or ethyl.

More preferentially still, the organosilane of formula (II) is chosen from 3-mercaptopropyltrimethoxysilane, 3-mercaptopropyltriethoxysilane, and mixtures thereof.

The composition according to the invention comprises the polyurethane P2 in a content of less than or equal to 4% by weight relative to the total weight of said composition.

More preferentially still, the composition comprises the polyurethane P2 in a content by mass of less than or equal to 3% relative to the total weight of said composition.

The polyurethane P2 preferably has a weight-average molecular mass (Mw) ranging from 5000 g/mol to 100 000 g/mol, more preferentially still from 8000 g/mol to 60 000 g/mol, and more preferentially still from 10 000 g/mol to 40 000 g/mol.

The weight-average molecular mass of the polymers may be measured by methods that are well known to those skilled in the art, for example by NMR or by size exclusion chromatography using polystyrene standards.

According to a preferred embodiment, the composition according to the invention comprises from 5% to 60% by weight of the mixture of polyurethanes P1 and P2 relative to the total weight of said composition.

### Rheological Agent

The composition according to the invention preferably comprises at least one rheological agent.

The rheological agent is preferably a thixotropic agent. A thixotropic agent generally influences the thixotropy of a composition. Thixotropy is the property of certain compositions to become less viscous when a constant force (for example shear at constant stress) is applied and, after the stress has ceased, the viscosity returns to its initial state after an appropriate period of time. The higher the force, the lower the viscosity.

In particular, the thixotropic agent may be chosen from:
PVC plastisols, corresponding to a suspension of PVC in a plasticizing agent which is miscible with PVC, obtained in particular in situ by heating to temperatures ranging from 60° C. to 80° C. These plastisols may be those described in particular in the publication Polyurethane Sealants, Robert M. Evans, ISBN 087762-998-6;
fumed silica;
suspensions in a plasticizer of bis-urea resulting from the reaction of a diisocyanate with a primary aliphatic amine;
waxes derived from castor oil, such as for example THIXCIN® R available from Elementis;
amide waxes, preferably micronized amide waxes, such as CRAYVALLAC® SLX, CRAYVALLAC® SLW or CRAYVALLAC® SUPER sold by Arkema, or else THIXATROL® AS8053 or THIXATROL® MAX which are available from Elementis, or else RHEOBYK 7503 sold by BYK; and
mixtures thereof.

Preferably, the thixotropic agent is chosen from amide waxes, suspensions in a plasticizer of bis-urea resulting from the reaction of a diisocyanate with a primary aliphatic amine, and mixtures thereof.

Preferably, the thixotropic agent is chosen from suspensions in a plasticizer of bis-urea resulting from the reaction of a diisocyanate with a primary aliphatic amine.

The suspension of bis-urea in a plasticizer preferably comprises:
from 1% to 40% by weight of a bis-urea obtained by reaction of a primary aliphatic amine with a diisocyanate with a molar mass of less than 500 g/mol, relative to the total weight of said suspension, and
from 60% to 99% by weight of a plasticizer chosen from alkyl phthalates, pentaerythrityl tetravalerate, esters of alkylsulfonic acid and of phenol, diisononyl 1,2-cyclohexanedicarboxylate, 3,3′-[methylenebis(oxymethylene)]bis[heptane], dioctyl carbonate and mixtures thereof, relative to the total weight of said suspension,
said suspension being a suspension of solid particles of bis-urea in a continuous phase of plasticizer.

Advantageously, the bis-urea is obtained by reacting an n-alkylamine comprising from 1 to 22 carbon atoms, preferably n-butylamine, with a diisocyanate of formula NCO—R⁶—NCO, in which R⁶ is chosen from one of the following divalent radicals of which the formulae below show the two free valencies:
i) the divalent radical derived from isophorone:

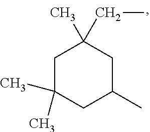

ii) the divalent radical 4,4′-methylenebis(cyclohexyl):

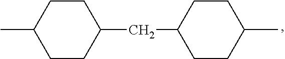

iii) the divalent radical derived from toluene 2,4-diisocyanate (or 2,4-TDI) or from toluene 2,6-diisocyanate (or 2,6-TDI) of respective formulae:

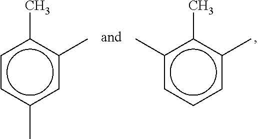

iv) the divalent radical derived from diphenylmethylene 4,2′-diisocyanate (or 4,2′-MDI) or from diphenylmethylene 4,4′-diisocyanate (or 4,4′-MDI), of respective formulae:

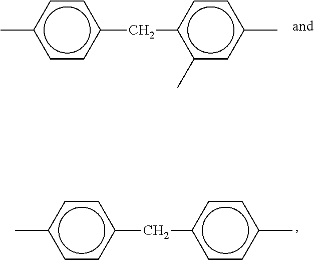

v) the hexamethylene radical: —(CH₂)₆—,
vi) the m-xylylene radical:

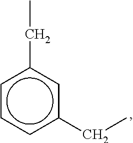

and
vii) the hexahydro-m-xylylene radical:

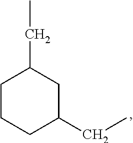

Preferably, R⁶ is the divalent radical derived from 4,2′-MDI or from 4,4′-MDI, more preferentially from 4,4′-MDI.

More preferably, the bis-urea is obtained by reacting n-butylamine with a diisocyanate of formula NCO—R⁶—NCO, in which R⁶ is the divalent radical derived from 4,2′-MDI or from 4,4′-MDI, preferably from 4,4′-MDI.

As indicated above for this embodiment, the plasticizer used in the bis-urea suspension is chosen from alkyl phthalates, pentaerythrityl tetravalerate, esters of alkylsulfonic acid and of phenol, diisononyl 1,2-cyclohexanedicarboxylate, 3,3′-[methylenebis(oxymethylene)]bis[heptane], dioctyl carbonate and mixtures thereof.

The alkyl phthalates are preferably formed by the group consisting of diisodecyl phthalate (DIDP), bis(2-propylheptyl) phthalate and mixtures thereof.

Advantageously, the plasticizer is chosen from alkyl phthalates, preferably from diisodecyl phthalate, di(2-propylheptyl) phthalate and mixtures thereof, and more preferentially is diisodecyl phthalate.

According to a preferred embodiment, the suspension of bis-urea in a plasticizer consists of:
from 1% to 40% by weight of a bis-urea obtained by reaction of a primary aliphatic amine with a diisocyanate with a molar mass of less than 500 g/mol, relative to the total weight of said suspension, and
from 60% to 99% by weight of a plasticizer chosen from alkyl phthalates, pentaerythrityl tetravalerate, esters of alkylsulfonic acid and of phenol, diisononyl 1,2-cyclohexanedicarboxylate, 3,3′-[methylenebis(oxymethylene)]bis[heptane], dioctyl carbonate and mixtures thereof, relative to the total weight of said suspension, said suspension being in the form of a suspension of solid particles of the bis-urea in a continuous phase of plasticizer, and the bis-urea and the plasticizer being as described above, including the embodiments.

Advantageously, said suspension comprises, and preferably consists of, from 5% to 30% by weight of bis-urea and from 70% to 95% by weight of plasticizer, the percentages being relative to the total weight of said suspension. The bis-urea and the plasticizer are as described above, including the embodiments.

The suspension of bis-urea in a plasticizer may be prepared according to the process described below.

The reaction of the primary aliphatic amine with the diisocyanate is highly exothermic. To prevent the large amount of heat formed by the reaction from leading to the decomposition of the bis-urea formed, the primary aliphatic amine and the diisocyanate are each dissolved in a plasticizer, prior to reacting them together, the plasticizer thus serving to evacuate the heat formed by the reaction. The two solutions in a plasticizer of the primary aliphatic amine and the diisocyanate are advantageously each introduced into a reactor via injectors, under a pressure of 40 to 200 bar, preferably of 80 to 120 bar, the two solutions thus being brought into contact in the sprayed liquid state. The amounts of reactants preferably correspond to a (number of moles of primary aliphatic amine)/(number of moles of diisocyanate) ratio of about 2. The bis-urea is produced by the reaction in the form of solid particles dispersed in a continuous phase of plasticizer, the Brookfield viscosity of the corresponding suspension, measured at a temperature of 23° C., being generally between 1 and 50 Pa·s, preferably between 10 and 25 Pa·s.

The term “waxes derived from castor oil” is understood to mean waxes obtained from castor oil, in particular hydrogenated castor oil.

The term “amide waxes” is understood to mean waxes comprising one or more compounds containing at least one amide group. In particular, amide waxes can be obtained from organic acid(s) (for example fatty acid(s)) and (di)amine(s).

The amide waxes are preferably micronized, that is to say that they have an average particle size of less than 1 mm. Advantageously, the amide waxes have an average particle size of less than 500 μm, preferably less than 100 μm, more preferentially less than 10 μm.

In the present description, the average particle size advantageously corresponds to the d50 particle size, i.e. the maximum size of 50% of the smallest particles by volume, and can be measured with a particle size analyser, in particular by laser diffraction on a Malvern machine (for example according to the standard ISO 13320).

Unless otherwise indicated, the standards mentioned throughout the patent application are those in force on the date of filing of the patent application.

Preferably, the content of rheological agent in the composition is between 1% and 45% by weight relative to the total weight of said composition, more preferably between 5% and 40% by weight, and more preferentially between 10% and 35% by weight.

### Filler

The composition according to the invention preferably comprises at least one filler.

The filler may be chosen from mineral fillers, organic fillers, and mixtures thereof, preferably from mineral fillers.

As examples of mineral filler, use may be made of any mineral filler customarily used in the field of adhesive compositions. These fillers are typically in the form of particles of various geometries. For example, they may be spherical, fibrous or irregular in shape.

The mineral fillers may be chosen from clays, quartz, carbonate fillers, kaolins, gypsum, hollow mineral microspheres, zeolites, and mixtures thereof.

Among the hollow mineral microspheres, mention may be made of hollow glass microspheres, and more particularly those made of sodium calcium borosilicate or of aluminosilicate.

Preferably, the mineral fillers are chosen from carbonate fillers, zeolites, and mixtures thereof.

Advantageously, the carbonate filler is chosen from alkali metal or alkaline earth metal carbonates and mixtures thereof. Preferably, the carbonate filler comprises calcium carbonate, more preferentially the carbonate filler is ground calcium carbonate and/or calcium carbonate coated with fatty acids (the latter preferably being precipitated).

When calcium carbonate is coated with fatty acids, this makes it possible to impart total or partial hydrophobicity to the calcium carbonate particles. Moreover, the fatty acid coating acts as a hydrophobic coating which can prevent the calcium carbonate from absorbing the constituents of the composition and from rendering them ineffective. The hydrophobic coating of the calcium carbonate can represent from 0.1% to 3.5% by weight, relative to the total weight of calcium carbonate.

Preferably, the fatty acids coating the calcium carbonate comprise or consist of more than 50% by weight of stearic acid relative to the total weight of the fatty acids.

Mention may be made, among alkali metal or alkaline earth metal carbonates, for example, of the chalk BL 200 TB sold by Omya (DV50=9 microns), Socal 312 sold by Solvay (hydrophobized calcium carbonate with a DV50 of 1 micron) or Omya BSH sold by Omya (hydrophobized calcium carbonate).

Advantageously, the zeolites are chosen from synthetic zeolites of type A, X and/or Y, preferably of type A, and have a pore diameter of between 3 Å and 5 Å, preferably of 3 Å.

The average particle size of the mineral filler may range from 10 nm to 400 μm; preferably from 20 nm to 100 μm, more preferentially from 30 nm to 50 μm.

As example of organic filler, mention may be made of any organic and in particular polymeric filler customarily used in the field of adhesive compositions.

Use may for example be made of polyvinyl chloride (PVC), polyolefins, rubber, ethylene/vinyl acetate (EVA), expandable or non-expandable hollow thermoplastic polymer microspheres (such as hollow vinylidene chloride/acrylonitrile microspheres) and/or aramid fibers (such as Kevlar®).

The PVC may be a PVC homopolymer and/or copolymer, preferably a PVC homopolymer.

As examples of PVC copolymers, mention may be made of copolymers obtained by polymerization of vinyl chloride with one or more monomers chosen from acrylonitrile, ethylene, propylene, vinylidene chloride and/or vinyl acetate, in particular vinyl acetate.

The size of the particles of the PVC filler may vary between 0.05 μm and 0.8 μm, preferably between 0.1 μm and 0.5 μm. The particle size can be measured by electron microscopy, in particular scanning electron microscopy.

The PVC filler can be obtained by emulsion.

There are various types of PVC filler commercially available.

Use may also be made of expandable or non-expandable hollow microspheres made of thermoplastic polymer. Mention may in particular be made of hollow microspheres made of vinylidene chloride/acrylonitrile.

Preferably, the composition according to the invention comprises at least a carbonate filler (preferably calcium carbonate) and a PVC filler.

Preferably, the composition according to the invention comprises from 5% to 50% by weight of filler(s), preferentially from 5% to 40% by weight, relative to the total weight of said composition.

### Other Additives

The composition according to the invention may further comprise at least one additive chosen from plasticizers, solvents, UV stabilizers, debubbling agents, adhesion promoters, and mixtures thereof.

Preferably, the composition comprises an additive chosen from plasticizers.

The additive chosen from plasticizers may be any plasticizer customarily used in the field of adhesive compositions.

This additive chosen from plasticizers may for example be chosen from diisodecyl phthalate, diisononyl phthalate (DINP), an ester of alkylsulfonic acid and of phenol (for example Mesamoll® sold by LANXESS), diisononyl hexahydrophthalate, pentaerythrityl tetravalerate, and mixtures thereof.

The content of additive chosen from plasticizers may range up to 10% by weight relative to the total weight of the composition.

The solvent may be chosen from aliphatic hydrocarbons (such as pentane, hexane, heptane, octane, nonane, decane, dodecane, isohexane, isooctane, isododecane, tetradecane, dodecylbenzene, cyclohexane, kerosene and naphthene), aromatic hydrocarbons (such as benzene, toluene, xylene, alkylbenzene, solvent naphtha, phenylxylylethane and diisopropylnaphthalene), halogenated hydrocarbons (such as carbon tetrachloride, dichloromethane, chloroform, ethyl bromide, trichloroethylene, tetrachloroethylene, trifluoroethylene, tetrafluoroethylene, trichlorotrifluoroethylene and tetrachlorodifluoroethylene), and mixtures thereof, preferably, from aromatic hydrocarbons, in particular diisopropylnaphthalene.

The content of solvent may range up to 10% by weight relative to the total weight of the composition, preferably from 0% to 5% by weight.

The composition according to the invention may comprise up to 1% by weight of one or more UV stabilizers (or antioxidants) relative to the total weight of said composition.

The UV stabilizers are typically introduced to protect the composition from degradation resulting from a reaction with oxygen which is liable to be formed by the action of heat or light. These compounds may include antioxidants that are capable of scavenging free radicals.

The UV stabilizer (or antioxidant) may be chosen from benzotriazoles, benzophenones, “hindered” amines such as bis(1-octyloxy-2,2,6,6-tetramethyl-4-piperidyl) sebacate, bis(2,2,6,6-tetramethyl-4-piperidyl) sebacate, bis(1,2,2,6,6-pentamethyl-4-piperidyl) sebacate (CAS No.: 41556-26-7), methyl 1,2,2,6,6-pentamethyl-4-piperidyl sebacate (CAS No.: 82919-37-7), octadecyl 3-(3,5-di-tert-butyl-4-hydroxyphenyl) propionate, 4,4′-bis(α,α-dimethylbenzyl)diphenylamine, and mixtures thereof.

Debubbling agents (or antifoams) are customarily used by those skilled in the art to enable the rapid elimination of bubbles formed during the preparation and application of compositions including a component comprising a polyisocyanate.

The debubbling agent may be any debubbling agent customarily used in the field of adhesive compositions.

For example, the debubbling agent may be a polysiloxane, an aldimine and/or an oxazolidine, in particular a polysiloxane.

The content of debubbling agent may range up to 2% by weight relative to the total weight of the two-component composition, preferably from 0% to 1% by weight.

The adhesion promoter may be chosen from aminoalkoxysilanes (such as (3-aminopropyl) trimethoxysilane, 4-amino-3,3-dimethylbutyltrimethoxysilane, N-(2-aminoethyl)-3-aminopropyltrimethoxysilane), mercaptoalkoxysilanes, epoxyalkoxysilanes (such as (3-glycidyloxypropyl) trimethoxysilane), and mixtures thereof.

Preferably, the composition does not comprise aminosilane.

Preferably, the composition does not comprise ethoxymercaptosilane, and more preferentially still the composition does not comprise mercaptosilane.

Preferably, the composition according to the invention comprises less than 4% by weight of polyurethane comprising two silylated terminal functions (devoid of isocyanate function), preferentially less than 2% by weight, and more preferentially still less than 1.5% by weight, relative to the total weight of the composition.

Preferably, the content of residual polyisocyanate (resulting from the preparation of the polyurethanes P1 and P2) in the composition is less than or equal to 0.5% by weight relative to the total weight of said composition.

The composition according to the invention may be prepared by simply mixing its ingredients.

### Use of the Composition

The present invention is also directed to the use of the composition as defined above as adhesive, in particular as semi-structural adhesive, as sealant or as coating.

In particular, the present invention is directed to the use of the composition as defined above as adhesive, sealant or coating, in the field of building construction, in the field of the manufacture of means of transport, such as the automobile, rail, aerospace or naval industries.

The composition according to the invention is as described above, including the embodiments and preferred characteristics.

The composition according to the invention advantageously has at least one of the following advantages:
it leads, after crosslinking, to a joint having an elongation at break of greater than 300%, more preferentially greater than or equal to 400%, more preferentially still greater than or equal to 600%;
it leads, after crosslinking, to a joint having an elastic recovery of greater than or equal to 70%;
it leads, after crosslinking, to a joint having a modulus at 100% elongation of less than or equal to 1 MPa;
it has a low content of residual polyisocyanate resulting from the preparation of the polyurethanes P1 and P2 (preferably less than or equal to 0.5% by weight relative to the total weight of said composition).

Those skilled in the art know how to determine the elongation at break of a composition. For example, the elongation at break can be measured according to the standard ISO37.

The elastic recovery can be measured according to the standard ISO 11600 of 2002, which refers to the standard ISO7389 of 2002, and at a constant rate equal to 5.5 mm/min.

The modulus at 100% elongation can be measured according to the standard ISO8339.

In particular, the elastic recovery and elongation at break can be measured as described in Example 4 below.

### Process for Assembling Substrates

The present invention also relates to a process for assembling substrates, comprising:
coating, onto at least one surface of the substrates to be assembled, the composition as defined above, then
bringing the substrates into contact.

The composition according to the invention is as described above, including the embodiments and preferred characteristics.

It is understood that, during the coating step and the contacting step, the composition according to the invention is in the uncured state.

The substrates may be identical or different.

The substrates concerned are very varied and are, for example, inorganic substrates, such as concrete, metals and/or alloys (such as aluminium alloys, steel, non-ferrous metals and galvanized metals), and/or organic substrates, such as wood, and/or plastics (such as PVC, polycarbonate, PMMA, polyethylene, polypropylene, polyesters, epoxy resins).

### Article

The present invention is also directed to an article comprising the composition according to the invention (cured or uncured), said composition binding at least two substrates of said article.

The composition according to the invention is as described above, including the embodiments and preferred characteristics.

The article may be obtained by the process for assembling substrates according to the invention (including the embodiments and preferred characteristics).

The substrates are preferably as described above for the process for assembling substrates according to the invention.

All of the embodiments described above may be combined with each other. In particular, the various abovementioned constituents of the composition, and in particular the preferred modes, may be combined with each other.

In the context of the invention, the term “of between x and y” or “ranging from x to y” is understood to mean an interval in which the limits x and y are included. For example, the range “of between 0% and 25%” includes in particular the values 0% and 25%.

The examples that follow are given purely by way of illustration of the invention and should not be interpreted as limiting the scope thereof.

### EXAMPLES

The following ingredients were used:
PVC powder (homopolymer) obtained by emulsion;
IPDI (Evonik): isophorone diisocyanate;
Omya BL (Omya): calcium carbonate;
TiO₂ (Kronos): rutile titanium dioxide;
Silane A187 (Evonik): ([3-(2,3-epoxypropoxy)propyl]trimethoxysilane);
Desmodur L75 (Covestro): aromatic polyisocyanate (approx. 75% in ethyl acetate);
Incozol BH (Incorez): aldimine (N,N-dibenzylidene polyoxypropylene diamine);
10% solution of salicylic acid in DPK, Disflamoll;
Catex E70 (Tib Chemicals): dibutyltin dilaurate;
Dynasylan@ MTMO (Evonik): mercaptosilane (3-trimethoxysilylpropane-1-thiol);
   Voranol™ P2000 sold by Dow is a polypropylene glycol (PPG) of functionality F=2 having an OHN of 55 mg KOH/g, i.e. a number-average molecular mass (Mn) in the region of 2040 g/mol;
   Polyol P: polyether polyol having a functionality of 3, and an OHN ranging from 45 to 50 mg KOH/g;
   Polyisocyanate T: 80/20 mixture of 2,4- and 2,6-TDI;
   IRGANOX® 1076: antioxidant sold by BASF;
   Tinuvin® 765: hindered liquid amine sold by BASF;
   DINP: diisononyl phthalate sold by Sigma Aldrich.

### Example 1: Preparation of an NCO-Terminated Polyurethane

The ingredients are mixed in a reactor maintained under constant stirring and under nitrogen, at 70° C.

The whole is kept stirring at this temperature until the hydroxyl functions of the polyols have been completely consumed.

The reaction progress is monitored by measuring the content of NCO groups by back titration of dibutylamine using hydrochloric acid, according to the standard NF T52-132. The reaction is halted when the content of NCO groups measured is approximately equal to the desired content of NCO groups (1.8%).

The proportions of the ingredients for the preparation of said polyurethane are indicated in the following Table 1 (% by weight):

TABLE 1

| | |
|---|---|
| Voranol ™ 2000L | 47.56% |
| Polyol P | 22.87% |
| PLASTICIZER | 19.34% |
| Polyisocyanate T | 9.53% |
| IRGANOX ®1076 | 0.42% |
| Tinuvin ® 765 | 0.27% |
| Catex E70 | 0.01% |

The percentages are percentages by weight relative to the total weight of the composition.

### Example 2: Preparation of the Bis-Urea (Rheological Agent)

Two solutions are prepared:
a solution A of n-butylamine in diisodecyl phthalate (DIDP), consisting of 17.17% by weight of n-butylamine and of 82.83% by weight of DIDP, the percentages being relative to the total weight of solution A, then
a solution B of 4,4′-MDI in DIDP, consisting of 29.46% by weight of 4,4′-MDI in 70.54% by weight of DIDP, the percentages being relative to the total weight of solution B.

The two solutions A and B are heated to 100° C. and then introduced, each under a pressure of 100 bar, into a reactor, in which they are sprayed continuously over each other in a ratio A/B=50.1/49.9 by weight, corresponding to an n-butylamine/MDI molar ratio equal to 2. The reaction is immediate and the temperature of the reactor reaches 140° C. at the end of manufacture.

At the reactor outlet, a stable 23.3% by weight (relative to the total weight of the dispersion) dispersion of a bis-urea in DIDP is obtained, the bis-urea having the formula:

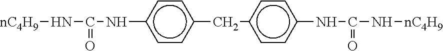

The Brookfield viscosity of the suspension, measured at 23° C., is 15 Pa·s.

### Example 3: Preparation of a Moisture-Crosslinkable Composition

The following composition was prepared according to the following procedure:

In a reactor, DINP and the polyurethane of Example 1 were added and mixed for 30 minutes at 23° C. The MTMO was added, and the reaction mixture stirred for 15 minutes at 23° C., so as to form a mixture comprising DINP, the polyurethane of Example 1 that has not reacted, and a hybrid polyurethane comprising an isocyanate end group and a silane end group resulting from the reaction of the MTMO with an NCO function of the polyurethane of Example 1. Monitoring via IR made it possible to show that of the MTMO was consumed. The polyurethane of Example 1: isocyanate-terminated and silane-terminated polyurethane mass ratio is greater than 94:6. The hybrid polyurethane is synthesized in situ and not isolated in the present case. Omya BL, PVC powder and titanium dioxide were then added to the reaction mixture and then this was mixed for 10 min. Then, the IPDI was added before mixing everything under vacuum (−0.8 bar) for 10 minutes. Next, the bis-urea of Example 2 was added under vacuum (−0.8 bar) for 5 min, and mixed for 10 minutes still under vacuum, before addition of the other ingredients. The mixture was stirred under vacuum (−0.8 bar) for 10 to 20 minutes.

| Ingredients | Composition C1 |
|---|---|
| DINP | 5.52 |
| Polyurethane of Example 1 | 31.5 |
| Dynasylan ®MTMO | 0.04 |
| Omya BL | 25.00 |
| PVC powder | 9.50 |
| TiO₂ | 4.15 |
| IPDI | 0.29 |
| Bis-urea of Example 2 | 21.00 |
| Incozol BH | 1.95 |
| Silane A187 | 0.09 |
| Desmodur L75 | 0.47 |
| Catex E70 | 0.03 |
| 10% solution of salicylic acid | 0.46 |
| total | 100 |

The ingredients in the table are indicated in % by weight relative to the total weight of the composition.

### Example 4: Properties of the Composition C1

The skinning time was measured in a controlled atmosphere at a temperature of 23° C. and a relative humidity of approximately 50%.

The composition was applied using a spatula in the form of a bead with a thickness of 2 or 3 mm. Immediately after the application of said bead, a stopwatch was started and it was examined every 5 minutes, using gentle pressure with a tongue depressor, whether the film is dry or whether a composition residue is transferred onto the depressor. The skinning time is the time at the end of which the composition bead is dry and for which there is no longer any transfer of product residue onto the tongue depressor. The result is expressed in minutes.

The measurement of the tensile strength and the elongation at break by a tensile test was carried out according to the protocol described below. The same applies for the Young's modulus.

The principle of the measurement consists in drawing, in a tensile testing device, the movable jaw of which moves at a constant rate equal to 500 mm/minute, a standard test specimen consisting of the crosslinked composition and in recording, at the moment when the test specimen breaks, the tensile stress applied (in MPa) and also the elongation of the test specimen (in %). The standard test specimen is dumbbell-shaped, as illustrated in the international standard ISO 37.

To prepare the dumbbell, the composition to be tested (packaged beforehand in a cartridge) is extruded into a Teflon mould, and is left to cure for 14 days under the standard conditions (23° C. and 50% relative humidity). The narrow part of the dumbbell used has a length of 20 mm (+/−0.5), a width of 4 mm and a thickness of 2 mm.

The modulus at 100% elongation was measured according to the test appearing in standard ISO11600 of 2002, which refers to standard ISO8339 of 2005: tensile stress corresponding to an elongation of the test specimen of 100%.

The elastic recovery was determined according to the test appearing in the standard ISO11600 of 2002, which refers to the standard ISO7389 of 2002.

The slump was measured according to the standard ASTM D2202.

The results are indicated in Table below:

| | Composition C1 |
|---|---|
| Skinning time (in min) | 90 |
| Extrusion rate (in g/min) | 105.1 |
| In-depth crosslinking (24 h-mm) | 3.9 |
| Elongation at break (in %) | 720 ± 0.76 |
| Modulus at 100% elongation (in MPa) | 0.86 ± 0.04 |
| Elastic recovery (in %) (ISO | 90.9 ± 1.3 |
| 7389-conditioning A) | |

Composition C1 advantageously results in an adhesive joint exhibiting, after crosslinking, good mechanical performance qualities, including:
an elongation at break of greater than or equal to 400%, preferably greater than or equal to 600%;
an elastic recovery of greater than or equal to 70%;
a modulus at 100% elongation of less than or equal to 1 MPa.

Composition C1 has an extrusion rate of 105.1 g/min, which allows easy application by the end user, for example via a gun.

### Example 5: Preparation of Moisture-Curable Compositions

The following compositions C2 and C3 were prepared according to the following procedure: In a reactor, DINCH and the polyurethane from Example 1 were added and mixed for 30 minutes at 23° C. Silane SILQUEST® A1110 (C2) or silane Dynasylan@ 1189 (C3) was added, and the reaction mixture was stirred for 15 minutes at 23° C., forming a mixture comprising DINCH, the unreacted polyurethane from Example 1, and a hybrid polyurethane with an isocyanate termination and a silane termination resulting from the reaction of silane SILQUEST® A1110 or Dynasylan@ 1189 with an NCO function of the polyurethane from Example 1. IR monitoring showed that all the silane was consumed. The mass ratio of polyurethane from Example 1 to isocyanate-terminated and silane-terminated polyurethane is greater than 94:6. The hybrid polyurethane is synthesized in situ and not isolated in this case. Omya BL, PVC powder, and titanium dioxide were then added to the reaction mixture and mixed for 10 minutes. Then, IPDI was added before mixing everything under vacuum (−0.8 bars) for 10 minutes. Next, the bis-urea from Example 2 was added under vacuum (−0.8 bars) for 5 minutes and mixed for another 10 minutes under vacuum, before adding the other ingredients.

The mixture was stirred under vacuum (−0.8 bars) for 10 to 20 minutes.

| Ingredients | Composition C2 | Composition C3 |
|---|---|---|
| DINCH | 5.30 | 5.36 |
| Polyurethane of example 1 | 31.46 | 31.47 |
| SILQUEST ® A1110 | 0.04 | — |
| Dynasylan ® 1189 | — | 0.04 |
| Omya BL | 25.00 | 24.97 |
| PVC powder | 9.50 | 9.50 |
| TiO₂ | 4.40 | 4.20 |
| IPDI | 0.29 | 0.29 |
| Bis-urea of example 2 | 20.95 | 21.00 |
| Incozol BH | 1.95 | 1.95 |
| Silane A187 | 0.1 | 0.1 |
| Desmodur L75 | 0.49 | 0.48 |
| Catex E70 | 0.04 | 0.04 |
| Sol 10% salicylic acid | 0.48 | 0.60 |
| total | 100 | 100 |

The ingredients in the table are indicated as % by weight relative to the total weight of the composition.

### Example 6: Properties of Compositions C2 and C3

The protocol and tests are similar to those in Example 4.

The results are shown in the following table:

| | Composition C2 | Composition C3 |
|---|---|---|
| Skin formation time (in min) | 100 | 105 |
| Elongation at break (in %) | 720 ± 20 | 770 ± 79 |
| Modulus at 100% elongation (in MPa) | 0.91 ± 0.06 | 0.84 ± 0.02 |
| Elastic recovery (in %) (ISO 7389 | 93.5 ± 0.5 | 94.1 ± 0.5 |
| conditioning A) | | |

Compositions C2 and C3 advantageously lead to an adhesive joint that, after curing, exhibits good mechanical performance, including:
an elongation at break greater than or equal to 400%, preferably greater than or equal to 600%;
an elastic recovery greater than or equal to 70%;
a modulus at 100% elongation less than or equal to 1 MPa.

### Example 7: Preparation of Moisture-Curable Composition C4

Composition C4 was prepared according to the following procedure: In a speedmixer reactor, Dynasilan MTMO was added to the polyurethane from Example 1, and the reaction mixture was stirred for 10 minutes at 30° C. at atmospheric pressure, forming a mixture comprising the unreacted polyurethane from Example 1 and a hybrid polyurethane with an isocyanate termination and a silane termination resulting from the reaction of MTMO silane with an NCO function of the polyurethane from Example 1. IR monitoring showed that all the silane was consumed.

Next, the obtained hybrid polyurethane is added to a mixture containing again the polyurethane from Example 1, Omya BL, PVC powder, and titanium dioxide. The reaction mixture was stirred for 10 minutes at 23° C. Then, IPDI was added before mixing everything under vacuum (−0.9 bars) for 15 minutes. Next, the bis-urea from Example 2 was added under vacuum (−0.9 bars) and the reaction mixture was stirred for another 10 minutes under vacuum, before adding the other ingredients.

The mixture was stirred under vacuum (−0.9 bars) for 10 to 20 minutes.

In formulation C4, the mass ratio of polyurethane from Example 1 to the hybrid polyurethane from the first step is greater than 94:6.

| | Step 1: Synthesis |
|---|---|
| | of the Hybrid |
| Ingredients | Prepolymer |
| Polyurethane from example 1 | 99.64 |
| Dynasilan MTMO | 0.36 |
| Total | 100 |
| | Step 2: |
| | Preparation of |
| | Composition C4 |
| | Composition C4 |
| Polyurethane from example 1 | 21.05 |
| Hybrid prepolymer from step 1 | 10.04 |
| DINCH | 5.71 |
| Omya BL | 25.68 |
| PVC powder | 9.36 |
| TiO₂ | 4.28 |
| IPDI | 0.11 |
| Bis-urea of example 2 | 20.79 |
| Incozol BH | 1.94 |
| Silane A187 | 0.09 |
| Desmodur L75 | 0.46 |
| Catex E70 | 0.03 |
| Sol 10% salicylic acid | 0.46 |
| total | 100 |

The ingredients in the table are indicated as % by weight relative to the total weight of the composition.

### Example 8: Properties of Composition C4

The results are shown in the following table:

| | Composition C4 |
|---|---|
| Skin formation time (in min) | 80 |
| Extrusion rate (in g/min) | 104 |
| Elastic recovery (in %) (ISO 7389- | 85 |
| conditioning A) | |

Composition C4 advantageously leads to an adhesive joint that, after curing, exhibits good mechanical performance, including an elastic recovery greater than or equal to 70%.

### Example 9: Preparation of Composition C5

The following composition was prepared according to the following procedure: In a reactor, DINCH and the polyurethane from Example 1 were added and mixed for 30 minutes at 23° C. MTMO was added, and the reaction mixture was stirred for 15 minutes at 23° C., forming a mixture comprising DINCH, the unreacted polyurethane from Example 1, and a hybrid polyurethane with an isocyanate termination and a silane termination resulting from the reaction of MTMO with an NCO function of the polyurethane from Example 1. IR monitoring showed that all the MTMO was consumed. The mass ratio of polyurethane from Example 1 to isocyanate-terminated and silane-terminated polyurethane is greater than 94:6. The hybrid polyurethane is synthesized in situ and not isolated in this case.

Omya BL, PVC powder, and titanium dioxide were then added to the reaction mixture and mixed for 10 minutes. Then, IPDI was added before mixing everything under vacuum (−0.8 bars) for 10 minutes, before adding the other ingredients.

The mixture was stirred under vacuum (−0.8 bars) for 10 to 20 minutes.

| Ingredients | Composition C5 |
|---|---|
| DINCH | 35.62 |
| Polyurethane of example 1 | 9.97 |
| Dynasylan ®MTMO | 0.05 |
| Omya BL | 30.43 |
| PVC powder | 13.70 |
| pigments | 1.4 |
| TiO₂ | 2.74 |
| IPDI | 0.13 |
| DINCH | 2.39 |
| Incozol BH | 2.47 |
| Silane A187 | 0.1 |
| Desmodur L75 | 0.52 |
| Catex E70 | 0.06 |
| Sol 10% salicylic acid | 0.42 |
| total | 100 |

The ingredients in the table are indicated as % by weight relative to the total weight of the composition.

### Example 10: Properties of Composition C5

The protocol and tests identical to those performed for Composition C1 were conducted. The results are shown in the following table:

| | Composition C5 |
|---|---|
| Skin formation time (in min) | 85 |
| Extrusion rate (in g/min) | 167 |
| Elastic recovery (in %) (ISO 7389- | 91 |
| conditioning A) | |

Composition C5 advantageously leads to an adhesive joint that, after curing, exhibits good mechanical performance, including an elastic recovery greater than or equal to 70%.

1. Moisture-crosslinkable composition comprising:
a polyurethane P1 comprising at least two isocyanate groups;
a polyurethane P2 comprising at least one isocyanate group and one group having the following formula (I): 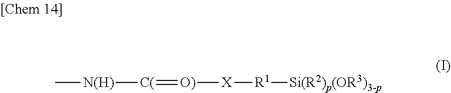
in which:
X represents S or NR⁴, R⁴ representing H, an alkyl group, an aryl group, or a cycloalkyl group;
R¹ represents a divalent hydrocarbon group comprising from 1 to 12 carbon atoms;
p is an integer equal to 0, 1 or 2;
each R², which may be identical or different, represents a linear or branched alkyl group comprising from 1 to 4 carbon atoms;
each R³, which may be identical or different, represents a linear or branched alkyl group comprising from 1 to 4 carbon atoms;
said composition being characterized in that the polyurethane P1: polyurethane P2 mass ratio ranges from 50:50 to 99:1.

2. The composition according to claim 1, characterized in that the polyurethane P1 is obtained via a process comprising a step E1 of polyaddition reaction:
(i) of a composition comprising a polyether diol and a polyether triol;
(ii) of a composition comprising a diisocyanate chosen from toluene diisocyanate, diphenylmethane diisocyanate, isophorone diisocyanate, xylylene diisocyanate.

3. The composition according to claim 1, characterized in that the polyurethane P1 has a content of NCO groups ranging from 0.5% to 10%.

4. The composition according to claim 1, characterized in that it comprises from 5% to 60% by weight of polyurethane P1, relative to the total weight of said composition.

5. The composition according to claim 1, characterized in that the polyurethane P2 comprises a terminal isocyanate group and an end group having the formula (I):

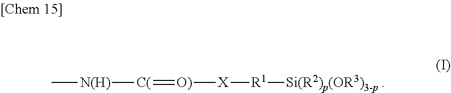

6. The composition according to claim 1, characterized in that the polyurethane P2 comprises a group of formula (I) in which:
X represents S; and/or
R¹ represents a linear or branched alkylene comprising from 1 to 6 carbon atoms; and/or
p represents 0; and/or
R³, which may be identical or different, represents methyl or ethyl.

7. The composition according to claim 1, characterized in that the polyurethane P2 comprises a group of formula (I) in which:
X represents S;
R¹ represents a linear or branched alkylene comprising from 1 to 6 carbon atoms;
p represents 0; and
R³, which may be identical or different, represents methyl or ethyl.

8. The composition according to claim 1, characterized in that the polyurethane P2 is obtained via a process comprising a step E2 of reacting a composition comprising a polyurethane P1 with at least one organosilane of the following formula (II): 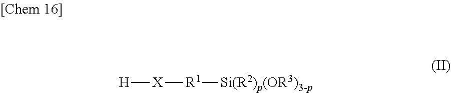
in amounts such that the NCO/XH molar ratio (r2) ranges from 70 to 200.

9. The composition according to claim 1, characterized in that it comprises the polyurethane P2 in a content of less than or equal to 4% relative to the total weight of said composition.

10. The composition according to claim 1, characterized in that the polyurethane P2 has a weight-average molecular mass (Mw) ranging from 5000 g/mol to 100 000 g/mol.

11. The composition according to claim 1, characterized in that it comprises at least one rheological agent.

12. The composition according to claim 1, characterized in that it comprises between 1% and 45% by weight of rheological agent relative to the total weight of said composition.

13. The composition according to claim 11, characterized in that the rheological agent is a thixotropic agent chosen from amide waxes, suspensions in a plasticizer of bis-urea resulting from the reaction of a diisocyanate with a primary aliphatic amine, and mixtures thereof.

14. The composition according to claim 13, characterized in that the suspension of bis-urea in a plasticizer consists of:
from 1% to 40% by weight of a bis-urea obtained by reaction of a primary aliphatic amine with a diisocyanate with a molar mass of less than 500 g/mol, relative to the total weight of said suspension, and
from 60% to 99% by weight of a plasticizer chosen from alkyl phthalates, pentaerythrityl tetravalerate, esters of alkylsulfonic acid and of phenol, diisononyl 1,2-cyclohexanedicarboxylate, 3,3′-[methylenebis(oxymethylene)]bis[heptane], dioctyl carbonate and mixtures thereof, relative to the total weight of said suspension,
said suspension being in the form of a suspension of solid particles of the bis-urea in a continuous phase of plasticizer.

15. The composition according to claim 1, characterized in that it comprises from 5% to 60% by weight of the mixture of polyurethanes P1 and P2 relative to the total weight of said composition.

16. The composition according to claim 1, characterized in that it comprises from 5% to 50% by weight of filler(s), relative to the total weight of said composition.

17. The composition according to claim 1, characterized in that it comprises at least a carbonate filler and a PVC filler.

18. The composition according to claim 1, characterized in that it does not comprise any aminosilane.

19. An adhesive comprising the composition according to claim 1.

20. Process for assembling substrates, comprising:
coating, onto at least one surface of the substrates to be assembled, the composition as defined in claim 1, then
bringing the substrates into contact.
